(19) United States
(12) Patent Application Publication
(10) Pub. No.: US 2024/0042734 A1
(43) Pub. Date: Feb. 8, 2024

(54) INTUMESCENT FIRE RETARDANT COATING AND METHOD OF TREATING THEREWITH

(71) Applicant: Performance Formulation Solutions, LLC., Grand Rapids, MI (US)

(72) Inventor: Futong Cui, Charlotte, NC (US)

(21) Appl. No.: 18/488,401

(22) Filed: Oct. 17, 2023

Related U.S. Application Data
(63) Continuation of application No. PCT/US2022/025786, filed on Apr. 21, 2022.
(60) Provisional application No. 63/179,779, filed on Apr. 26, 2021.

(51) Int. Cl. B32B 15/10; B32B 21/04; B32B 15/20; B32B 7/12; B32B 3/26

(52) U.S. Cl. CPC B32B 15/10; B32B 21/04; B32B 15/20; B32B 7/12; B32B 3/266; B32B 2255/08; B32B 2307/3065; B32B 2307/7376; B32B 2250/02

(57) ABSTRACT

A fire-resistant wood-based product and method of forming such a wood product are described. The wood-based product includes an intumescent layer disposed against a wood, wood product, or wood composite. The intumescent layer is substantially covered by a non-flammable radiant barrier. The non-flammable radiant barrier is disposed directly over the intumescent layer.

### CROSS-REFERENCE TO RELATED APPLICATION(S)

This application is a continuation of International Application No. PCT/US2022/025786, filed Apr. 21, 2022, which claims the benefit of U.S. Provisional Patent Application No. 63/179,779, filed Apr. 26, 2021, all of which are incorporated herein by reference in their entirety.

### BACKGROUND

The statements in this section merely provide background information related to the present disclosure and may not constitute prior art. Intumescent barriers are used for fire protection. The most common intumescent coating comprises three components: a char former, a charring catalyst, and a blowing agent. The char former is typically a poly-alcohol such as pentaerythritol or di-pentaerythritol. An acid catalyst, most commonly ammonium polyphosphate, is present to catalyze the charring of the char former. A blowing agent, such as melamine, provides non-flammable gases to help the carbon to foam and expand in order to form the low-density insulating foam.

### BRIEF DESCRIPTION

An aspect of the present disclosure relates to a method of forming a protected wood product, the method comprising coating a first side of a rigid body with an intumescent material, the intumescent material being a wet paste or liquid comprising a binder, a blowing agent, and a charring agent, the rigid body having the first side and a second side, the second side opposing the first side, and wherein at least the first side is a wood, wood product, or wood composite, pressing a metal foil radiant barrier to the intumescent material, the radiant barrier comprising a plurality of perforations, and curing the intumescent material after the pressing.

Another aspect of the present disclosure relates to a manufactured fire resistant wood-based product comprising an intumescent layer disposed against a wood, wood product, or wood composite, wherein the intumescent layer is substantially covered by a non-flammable radiant barrier disposed directly over the intumescent layer wherein the radiant barrier is perforated to be gas permeable and is disposed directly over the intumescent layer.

### BRIEF DESCRIPTION OF THE DRAWINGS

A full and enabling disclosure of the present description, including the best mode thereof, directed to one of ordinary skill in the art, is set forth in the specification, which refers to the appended FIGS., in which:

FIG. 1 illustrates a schematic view of a wood product according to an aspect of the present disclosure.

FIGS. 2 to 5 each show exemplary flame tests using non-perforated foil.

### DETAILED DESCRIPTION

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value.

The word “exemplary” is used herein to mean “serving as an example, instance, or illustration.” In addition, references to “an aspect” or “one aspect” does not necessarily refer to the same aspect, although it may. Any implementation described herein as “exemplary” or “an aspect” is not necessarily to be construed as preferred or advantageous over other implementations. Moreover, each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one aspect can be used with another aspect to yield a still further aspect. Thus, it is intended that the present disclosure covers such modifications and variations as come within the scope of the appended claims and their equivalents.

In the present disclosure, when a coating or layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

As used herein, the term “substantially free” is understood to mean completely free of said constituent, or inclusive of trace amounts of same. “Trace amounts” are those quantitative levels of chemical constituent that are barely detectable and provide no benefit to the functional or aesthetic properties of the subject composition. The term “substantially free” also encompasses completely free.

As used herein, the term “substantially covered” is understood to mean completely covering said component, or covering all but trace areas of the same. “Trace areas” are those surface areas of said component that provide no detriment to the functional or aesthetic properties of the subject covering. The term “substantially covered” also encompasses completely covered.

The present disclosure relates generally to a fire resistant barrier comprised of an intumescent coating disposed against and substantially covering a wood, wood product, or wood composites including wood or cellulose, said intumescent coating coated with a non-flammable radiant barrier disposed directly over the intumescent barrier, wherein the radiant barrier is perforated to be gas permeable and is preferably disposed directly over the intumescent barrier with no glue or other flammable material. The present disclosure further relates to a method of manufacture of fire resistant wood products, said products manufactured by applying an intumescent coating onto wood, and then applying a radiant barrier with no glue directly to the intumescent barrier so formed before the intumescent barrier has set.

A fire-resistant wood-based product is described. The product contains an adhesive intumescent material disposed over the wood-based material, and a radiant barrier disposed directly over the intumescent material, with no non-intumescent glue being used in the construction. The radiant barrier, for example aluminum foil, is perforated so as to allow gas expansion during exposure to heat or fire to escape from behind the radiant barrier, thereby preventing the radiant barrier from excessive bubbling and dislodging from the intumescent material. The perforation also allows water vapor diffusion when the material is used in a construction.

The basic components of the intumescent formulation used here are an acid source (e.g., ammonium polyphosphate), char former (e.g., pentaerythritol) and a blowing agent (e.g., melamine). On heating, the acid source produces an acid, which catalyzes dehydration reactions of the char former, resulting in the formation of char. In the meantime, the blowing agent produces inert gas, which inflates the char. The thickness, coherence and porosity of the char determines its thermal barrier efficiency. Ammonium polyphosphate (APP) for example decomposes around 215° C. to produce polyphosphoric acid. The acid esterifies the carbon sources between 280 and 330° C., while both of them are in semi-liquid stage. The ester decomposes via dehydration reaction resulting in the formation of a carbonaceous char. In the meantime, the blowing agent decomposes while char is still in a semi-liquid stage and the formed gas expands the char, into a porous structure of very low thermal conductivity. Melamine, for example sublimes at 250° C. and over the temperature range of 270-400° C. releases large amount of ammonia. As the reaction completes, solidification of the char occurs. Further exposure to the heat source results in ablation of the char.

When exposed to fire, a binder is advantageously present which melts and functions as an adhesion agent for the expanding foam created by the decomposing blowing agent. Latex binder is easy to incorporate and apply and latex is the least expensive binder in most circumstances. However, latex based intumescent coatings are prone to water damage. Although epoxy and isocyanate-based binders are more water resistant, they are expensive and difficult to apply.

Topcoats with high binder contents can be used on top of the intumescent coating to provide water resistance. This adds material and labor cost. Unless fire retardants are added to the topcoats, they cause flash-over problems in case of fire.

In the US, fire retardant construction materials are highly regulated. For quality and compliance reasons, fire retardants are factory applied. After applying the intumescent coating, the coated material must be dry before stacked. Depending on the glass transition temperature (Tg) of the binder material, the coated materials may stick to each other (known as blocking) after the coating is dry. To deal with this problem, anti-blocking agents (waxes and polymers) maybe used. Alternatively, binders with high Tg maybe used. However, binders of high Tg have poor flexibility and the coating may crack with temperature or moisture fluctuations.

The International Code Council (ICC) Acceptance Criteria AC479 is a guidance document for code compliance listing of intumescent coatings. One requirement of AC479 is a series of water spray-UV exposure tests. A 100% solids UV-cured polymer system can be used as a topcoat and although this system was efficient in reducing the leaching of fire-retardant components, it suffers severe cracking damage in a UV exposure cycle.

Intumescent coatings have been used for fire protection for decades. The most common intumescent coating has three components: a char former, a charring catalyst, and a blowing agent. The char former is typically a poly-alcohol such as pentaerythritol or di-pentaerythritol. An acid catalyst, most commonly ammonium polyphosphate, is present to catalyze the charring of the char former. A blowing agent, such as melamine, provides non-flammable gases to help the carbon to foam and expand in order to form the low-density insulating foam. Finally, a binder is present to bind the materials together. When exposed to fire, the binder melts and functions as an adhesion for the expanding foam. Latex binder is easy to apply and the least expensive. However, latex based intumescent coatings, and all water-based intumescent formulations, are prone to water damage. Although epoxy and isocyanate-based binders are more water resistant, they are expensive and difficult to apply.

Aspects of the present disclosure can be used with a wide variety of intumescent compositions. For example, U.S. Pat. No. 7,045,079 describes an aqueous fire barrier composition including latex including a polymer; from 1% to about 10% by weight polyol having 2, 3 or 4 hydroxy groups, and an intumescent agent. Preferred polymers are acrylate, methacrylate, vinyl acetate and combinations thereof, for example an acrylate-vinyl acetate-ethylene terpolymer, rubber, a styrene butadiene copolymer, a butadiene acrylonitrile copolymer, polyisoprene, and polybutadiene. The described intumescent agent is a composition that includes granular alkali metal silicates represented by the formula M₂-O:XSiO₂ in which M is an alkali metal, X is at least one oxyboron compound selected from the group consisting of boric acid and borate salts of Group I and Group II elements, and water bound to said alkali metal silicate. Suitable intumescent agents include, e.g., hydrated alkali metal silicates (e.g., sodium silicate, lithium silicate and potassium silicate with bound water), expandable graphite, unexpanded vermiculite, melamine (i.e., 2,4,6-triamino-1,3,5-triazine), azocarbonamide and benzene sulfonyl hydrazide. The composition can also include a fire retardant agent such as aluminum oxide trihydrate or zinc borate. While such a composition is not similar to the compositions described in the present disclosure, aspects of the present disclosure are applicable to this composition.

Various techniques are available in order to increase the water resistance of intumescent coatings. Surface coated or encapsulated ammonium polyphosphate (APP) is commercially available. Coated APP has limited benefits in terms of water resistance. Pentaerythritol and melamine have high water solubility, leading to poor water resistance of the coating.

Since these intumescent coatings maybe subjected to frequent rain and high humidity conditions, the water soluble components are leached out and the coating loses most of its fire-retardant properties. Cost-effective selections for the intumescent formulation, such as pentaerythritol and melamine, have high water solubility, leading to poor water resistance of the coating. Generally, it has been necessary to vary intumescent formulation components in ways that increase price, oftentimes decrease intumescent behavior and/or decrease the flexibility of the intumescent paint. Various techniques are available in order to increase the water resistance of intumescent coatings. Surface coated or encapsulated ammonium polyphosphate is commercially available. Coated APP has limited benefits in terms of water resistance. Topcoats with high binder contents can be used on top of the intumescent coating to provide water resistance. This adds material and labor cost. Unless fire retardants are added to the topcoats, they cause flash-over problems in case of fire.

Most commercial radiant barrier materials are made by metal deposition on fiber reinforced plastic materials. The fiber and plastic are combustible and/or flammable, giving poor fire performance. In construction, adjacent panels such as roof and wall sheathing are placed with a 1/16″ to ⅛″ gap. For traditional radiant barrier materials, this gap can be an entry point for fire ignition and spread unless the radiant barrier wraps around the edges of the 4×8′ panels. Still, when panels are cut in the field, the cut edge is a weak point for fire ignition and spread.

Building products with a radiant barrier can lead to significant energy savings. Unfortunately, fire retardant manufacturers do not recommend the use of radiant barriers on fire retardant treated wood products. This is due to the fact that almost all fire retardants in use today are based on phosphates which leads to strength reductions, especially at high temperatures. The strength adjustment factors published in building codes will not apply if a radiant barrier is present.

Most commercial radiant barrier materials are made by metal deposition on fiber reinforced plastic materials. The fiber and plastic are combustible and/or flammable, so while the radiant barrier reflects heat, the structure itself gives poor fire performance. Simple metal foil can be a radiant barrier, but such unsupported material is subject to tearing and penetrations during installation and subsequent construction. Another commercial product is a two-sided radiant barrier is made of two layers of aluminum foil laminated to a layer of woven polyethylene, giving the sheet excellent tear resistance, and is available with perforations so it can allow vapor transmission. These perforations allow slow gas migration through the barrier, facilitating drying if the underlying material is wetted during construction or for example if flooding accidents occur. Some foam board material used to clad construction has perforated outer barriers.

Intumescent layers may include a facer material, where the facer material may include, for example, a polymeric film, a metallized plastic film, a woven or non-woven fabric, a foil, or even paper. Traditionally, the radiant barrier material is applied to wood panels by using a flammable glue.

In construction, adjacent panels such as roof and wall sheathing are placed with a 1/16″ to ⅛″ gap. For traditional radiant barrier materials, this gap can be an entry point for fire ignition and spread unless the radiant barrier wraps around the edges of the typically 4 foot by 8 foot panels. Still, when full panels are cut in the field, the cut edge is a weak point for fire ignition and spread. Indeed, this phenomenon is so universally prevalent that new fire resistance testing requires testing with a gap cut into the wood sample. Wood and wood products protected by a simple glued on radiant barrier will be susceptible to flame and will not pass the regulatory tests.

Prior art intumescent coatings have been applied as films, i.e., paints or mastic coatings, directly to the surface to be protected in liquid form by brushing, rolling or spraying. Generally, pretreatment of this surface is necessary prior to application of the intumescent coatings, and several coatings are usually required in order to achieve the necessary fire-retardant protection. Similarly, it is difficult to obtain uniform coatings.

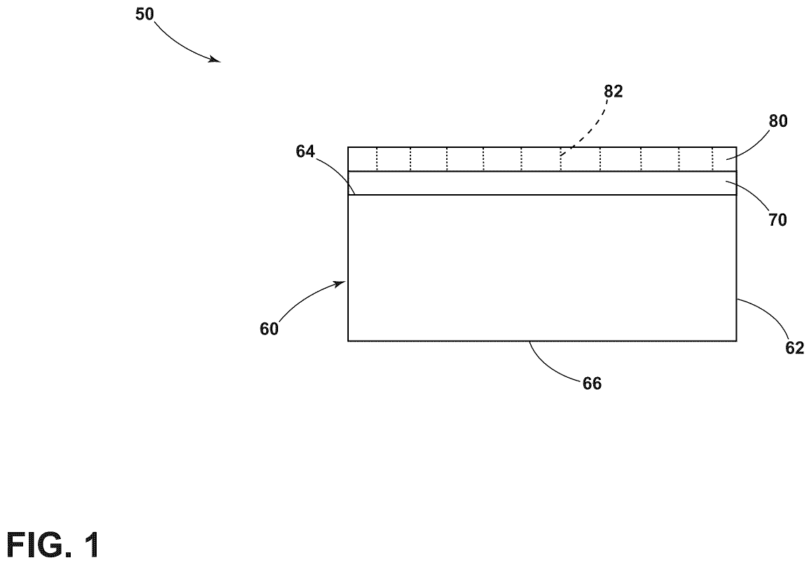

Referring now to FIG. 1, the present disclosure relates generally to a fire resistant barrier comprising a fire resistant or protected wood-based product 50 comprised of an intumescent coating 70 disposed against a rigid body 62 of a wood, wood product 60, or wood composite including wood or cellulose, the rigid body 62 having a first side 64 and an opposing second side 66, said intumescent coating 70 disposed against the first side 64 and coated with a non-flammable radiant barrier 80 disposed directly over the intumescent barrier 70 with no intermediate non-intumescent glue, wherein the radiant barrier 80 is perforated with a plurality of perforations 82 to be gas permeable and is preferably disposed directly over the intumescent barrier 70 with no glue or other flammable material. Preferred characteristics of the radiant barrier 80 are 1) sufficient perforations 82 to allow gas to escape, and which facilitates wet intumescent material 70 drying, and which prevents the radiant barrier 80 from being excessively forced away from the intumescent material 70 by gas pressure generated by a subsequent fire interacting with the intumescent material 70 in an enclosed environment of the rigid body 62 and the radiant barrier 80. The radiant barrier 80 is substantially waterproof, excepting small perforations 82 which are formed to discourage passage of liquid water, thus protecting the underlying intumescent material 70 from water damage. The present disclosure further relates to a method of manufacture of fire resistant wood products 50, said products 50 manufactured by applying an intumescent coating 70 onto wood or processed wood 60, cellulose, and the like, and then applying a radiant barrier 80 to the intumescent barrier 70 so formed before the intumescent barrier 70 has set. The radiant barrier 80 is advantageously hot rolled and pressed directly onto the unset intumescent layer 70. Another very important advantage of applying the perforated foil barrier 80 to the uncured intumescent material 70 is that this allows treated products 50 to be packed, stacked, or the like before the intumescent material 70 has fully cured. This is a significant advantage in production. If uncoated, the applied layers of intumescent material 70 will adhere to packing or to one another. The perforations 82 may allow unwanted gas pockets that may have formed below the radiant barrier 80 during installation to be pressed out.

Preferred radiant barriers 80 have sufficient perforations 82 to allow gas to escape. Said perforations 82 allow wet intumescent material 70 to dry and/or set. Said perforations 82 prevent the radiant barrier 80 from being overly forced away from the intumescent material 70 by gas pressure generated by a subsequent fire interacting with the intumescent material 70 and gas pockets below the radiant barrier 80. The radiant barrier 80 protects the bulk of the intumescent material 70 from water damage, especially during construction. Said perforations 82 also allow evaporation of water (or other solvent), that may incidentally wet the board 60.

A balancing factor on the size, spacing, and shape of the opening 82 in the preferred radiant barrier 80 also protects the underlying intumescent material 70 from water. Therefore, perforations 82 should be of sufficient size, shape, and otherwise treated to minimize water permeation. Generally, less than 5% of area should include perforations 82, typically less than 1% of area, where the area of perforation 82 is the area where the underlying material can be seen. Generally small holes are better at keeping out water, but micro perforations that exclude water completely will have insufficient gas permeability. One solution is to make perforations 82 in the shape of slits, where the length of the slit 3 times, preferably 5 time, or 8 times or more the width of the slit. The foil 80 treated in this manner can have very low permeability to water, but as the foil 80 gets disturbed by the expansion of underlying intumescent material 70 during a fire, the slits will tend to open and deform to provide good permeability to gas while still providing a radiant shield 80.

One preferred method of forming the perforations 82 on the radiant barrier 80 is with a roller or press having spaced protrusion thereon, where when the protrusions are pressed against foil 80 disposed directly against intumescent material 70, where the intumescent material 70 behind the foil 80 is itself disposed against the wood 60 and is cured, partially cured, or uncured. The protrusions then press through the foil 80 and at least partially into the underlying intumescent material 70. The protrusions can be in a pointed tapered needle shape, thereby only slightly disturbing the underlying intumescent layer 70. The protrusions may be rod-shaped, forming holes 82 through the radiant barrier 80 and into the intumescent layer 70, where said holes 82 may extend partially or fully through the intumescent layer 70. This is not preferred, because the holes 82 would allow water to sit against the intumescent material 70, allowing the water to dissolve components of the intumescent material 70. The protrusions may be coated with a silicone water repellent material.

In one example, the protrusions are hollow rods, puncturing the radiant barrier 80 but advantageously leaving the radiant barrier 80, for example aluminum foil, substantially intact. In this example the perforations 82 can be larger, for example more than 0.05 inches, or for example more than 0.1 inches, in diameter, where the perforation 82 diameter is beneficially less than for example than 0. 5 inches, more preferably less than 0.2 inches. Alternately, the foil 80 can be perforated with round or oval holes 82, where simple experimentation with a particular foil barrier 80/intumescent layer 70 can help optimize the size and number of permeations 82. The circular foil protects the center of the protrusion from water, and also provides a layer 80 which, while it may dislodge during fire, protects the underlying intumescent material 70 from flame for a period of time.

Another example has perforations 82 shaped with a profile having an angle, for example a “U” shape or a “V” shape. The cut into the radiant barrier 80 can be very narrow, limiting the amount of water that may penetrate, but in the event of fire these very small perforations 82 can open up, providing added gas permeability while having the flap continue to protect the underlying intumescent layer 70.

Perforations that allow passage of water vapor but not liquid water are known. But such systems are not preferred since the gas permeability is so low. Testing regarding whether the perforations 82 are sufficiently sized can be by for example providing localized flame near the center of a treated board 50, resulting in underlying expansion of the foil 80. Small bubbles may form as gas behind the radiant barrier 80 expands, which will not affect the performance of the layer 80 unless the expanded bubbles cause the radiant barrier 80 to rip or be punctured, or dislodge completely from the intumescent layer 70. The foil 80 may rip, because it is not expandable, but small tears should not overly expose uncharred areas, and optimally the foil 80 should not be forced from unexpanded intumescent material 70 more than is needed to accommodate the expanded portion.

There is no flammable, and preferably no non-intumescent, glue layer between the intumescent material 70 and the radiant barrier 80. In preferred examples there is no non-intumescent glue or other layer between the intumescent material 70 and the radiant barrier 80, and no glue layer between the intumescent material 70 and the wood or wood product 60.

The intumescent barrier 70 may include first and second layers (and more if needed to provide varying properties or additional thickness) disposed one over the other, each intumescent layer optionally having same or different compositions, or preferably may be a single layer. The radiant barrier 80 may include one or more layers, provided one layer is metal foil. In preferred examples the radiant barrier 80 includes only metal foil, preferably aluminum foil.

As used herein, the phrase “intumescent material” 70 means a formulated intumescent composition, including at least a gas-producing material, a charring agent, and a binder which can also char. This phrase is used interchangeably with intumescent composition and intumescent mixture. Preferred intumescent materials 70 are water-based, that is, the composition is applied to wood 60 as an aqueous slurry or mixture. As used herein, unless otherwise specified, compositions of materials are expressed in weight percent. As used herein, “radiant barrier” 80 means a perforated reflecting barrier of thickness less than about 0.02 inches, typically less than 0.01 inches thick, for example between 0.01 and 0.3 mm thick. Aluminum foil is preferred. The radiant barrier 80 must be able to move and deform as the underlying intumescent material 70 expands. As used herein, “perforated” means the intumescent barrier 80 has holes, cuts, or combinations of such, of such size and thickness to allow the underlying intumescent material 70 to dry after application, and to allow a reasonable portion of gas generated behind the intumescent layer 80 during a fire to migrate through said perforations 82. Generally, a perforation 82 hole effective diameter of half a millimeter to a millimeter spaced every half inch would be a minimum. Cuts 82 of length of between about 1 to 10 mm can be very effective, as when the foil 80 is being deformed by expanding intumescent material 70 the cuts 82 in the foil 80 may “open” a few millimeters to allow more effective gas escape. Preferably, the radiant barrier 80 is applied directly to wet viscous intumescent material 70. If applied by for example rollers, there is substantially complete contact between the radiant barrier 80 and the intumescent material 70, with no air bubble being trapped below the radiant barrier 80.

Generally, intumescent coatings 70 of 10 to 250 grams per square foot are used. Intumescent coating 70 can be applied at a rate of 10 grams to about 200 grams per square foot, more typically between 20 grams to 120 grams per square foot, for example between 30 grams and 60 grams per square foot. Similar protection is obtained with an amount of intumescent material 70 as is obtained with about one half to two thirds of the intumescent material 70 with the perforated foil 80 bonded thereto.

Intumescent material 70 formulations, and manufacture thereof, are known in the art. A simple MUF intumescent material contains ammonium polyphosphate, pentaerythritol, melamine, urea and/or formaldehyde solution, sodium hydroxide and melamine. A resin can be prepared with formaldehyde, melamine and urea by mixing a formaldehyde solution and urea in a reactor, and the pH is then adjusted to 8.0-9.0 with NaOH. The mixture was heated to 90° C. for a period of time, for example 30 min. Then the pH is adjusted to about 5.5 with ammonium chloride, followed by the addition of additional urea and melamine. Advantageously, the intumescent composition can contain fillers, fiber, pigments, and the like normally incorporated in intumescent layers. This example is exemplary and may not have been used in the examples.

Advantageously, there is no continuous structure of fibers, paper, or impermeable layers below or within the intumescent layer 70. Such material may cause weakness in the intumescent layer 70 as an adjacent section is subject to heat and begins to expand, which can result in dislodging intumescent material 70 from the wood. Paper and certain fiber material can burn. Advantageously, the intumescent layer 70 consists essentially, or consists of, the intumescent formulation, and the radiant barrier 80 consists essentially, or consists of, aluminum foil.

One of the challenges for a fire retardant coating is its water resistance. Even for interior applications, the coating is required to have certain water resistance to deal with exposures during the construction stage. For water-based intumescent coatings, water resistance is a particular challenge. We found that the use of aluminum foil radiant barrier 80 can effectively provide the required water resistance according to ICC AC-479 even for intumescent formulations which may otherwise have difficulties passing these strict standards.

To reach permeability requirements, radiant barriers 80 are often perforated. Perforation 82 can be spaced from 1 mm to 50 mm, typically between 2 mm to 20 mm, or between 5 mm and 15 mm, or combinations of the endpoints of these various ranges, and the size (effective diameter) of the perforation 82 can be 0.01 mm or lower to 10 mm, typically between 0.1 to 5 mm in diameter, for example from 0.3 mm to 2 mm, or combinations of the endpoints of these various ranges. Perforations 82 need not be round but as a practical matter round or square perforations 82 are easy to form. The spacing of perforations 82 can be any combination or the above ranges, and size of perforations 82 is in one example greater than 1 mm, for example greater than 5 mm, to allow gas to readily escape during a fire. The radiant barrier 80 is perforated to be gas permeable and is preferably disposed directly over the intumescent barrier 70 with no glue or other flammable material. The intumescent layer 70 itself acts as the glue. Care should be taken to prevent intumescent material 70 from plugging the holes 82. Perforation of the foil 80 while needles are coated with water repellant material, for example a silicon based water repellant, is useful in this regard.

The foil 80 may be applied to the dry intumescent coating 70 with a very thin layer of latex-based adhesive followed by perforation. This is not preferred unless the latex material is itself a non-flammable intumescent material. Non-flammable glues may be used if the glue does not affect the performance of the underlying intumescent material 70. It is preferred, however, if an intermediate glue layer is desired to use an intumescent primer coat composition as adhesive. More preferably the perforated metallic foil radiant barrier 80 is held to the intumescent material 70 by the intumescent composition itself, which may be made more adhesive by adding adhesion-promoting compounds to the intumescent material 70, preferably silicone-based adhesion promoting compounds.

The intumescent material 70 can be applied as a single coating or as several coatings. Intumescent coating 70 can be applied at a rate of 20-120 grams per square foot, more preferably 30-60 grams per square foot. Clearly, the intumescent coating 70 is applied to the wood 60. If multiple layers of intumescent material 70 are to be applied, an underlying layer can be dried until it is no longer tacky before applying added layers of intumescent material 70.

To further improve the water resistance of the intumescent coating 70, water repellents and other known additives can be incorporated into the intumescent formulation. Adhesion promoters including for example the preferred class of silanes can be added to the formulation. Adhesion promoters are chemicals that can act at the interface between an organic polymer and an inorganic surface to enhance adhesion between the two materials. A silicon-based chemical that will function as an adhesion promoter typically has a general structure of four substituents attached to a single silicon atom. The most common structure has three inorganic-reactive alkoxy groups, such as methoxy or ethoxy, and one organic group, or two alkoxy groups and two organic groups. While 3-aminopropylmethyldiethoxysilane adhesive is preferred, other useful adhesion promoters include for example 3-(ethoxydimethylsilyl) propylamine, (3-aminopropyl) triethoxysilane, (3-aminopropyl) triethoxysilane, vinyltriethoxysilane, and similar silanes. It is within the skill of one in the art to select an adhesion promoter that is non-flammable when admixed into the intumescent material 70.

Alternatively, or additionally, in one example, a very thin layer (0.0001-0.02 mm) of low viscosity intumescent coating 70 containing a silane adhesion promoter can be applied to the foil 80 before it is pressed to the wet intumescent coating 70.

The advantages of the present disclosure are numerous. Panels 50 can be stacked as soon as the foil 80 is applied, and perforations 82 created. This saves the need of maintaining the bulky treated material out for drying the coating. This present disclosure provides a product 50 with excellent fire resistance while having a radiant barrier 80. Since the fire retardant properties comes from an intumescent coating 70, the strength properties are not negatively impacted. The radiant barrier 80 protects the intumescent material 70 from external water damage. The presence of the radiant barrier 80 over the intumescent layer 70 will increase the effectiveness or operable lifetime of the char. The perforations 82 in the radiant barrier 80 allow the intumescent layer 70 to dry, and allows vapor to pass through in the event the underlying wood 60 is exposed to water. The radiant barrier 80 will also keep the intumescent material 70 from being abraded, which can cause a treated surface to lose effectiveness and create dust. To further improve the water resistance of the intumescent coating 70, water repellents and other known additives can be incorporated into the intumescent formulation. If desired, stabilizers, fungicides, bactericides and other additives may be included in the intumescent formulations in amounts ranging between 0.1 and 5 percent by weight. Again, adhesion promoters such as silanes can be added to the formulation.

Advantageously, the radiant barrier 80 is metal foil, preferably aluminum foil. Reinforcing fibers can be present in or on the foil, but this can create issues with the fibrous material causing stresses in adjoining intumescent material 70 during for example sawing a board 50, which may in extreme cases cause loss of intumescent material 70 very near the cut. Also, the foil should not be mistaken for a structural element. The foil should be such that is cuts readily, and can bend and adjust as the intumescent material 70 expands unevenly over a panel 60. Thickness of 0.005 to 0.05 mm foil, preferably 0.01 to 0.02 mm, foil is preferred. While aluminum foil is preferred esthetically, economically, and due to good reflective properties, any metal foil having a melting temperature greater than 660° C. can be used, including copper, alloys, and even very thin steel, so long as the foil can be perforated and can substantially bend without breaking.

Foil is, generally, not stretchable and does not have compressive strength. During fires, parts of a foil will start to move away from the wood as the intumescent coating expands while other parts of the foil are as yet unaffected. The presence of air bubbles between the radiant barrier 80 and the intumescent material 70 was identified as a primary cause of large bubbles forming during flame testing. While such bubbles may on a small scale be insulating, very large bubbles can cause the foil 80 to release or form large tears. Glass fibers and the like may reduce tearing, but the entire film may be pulled away from the intumescent material 70. This glass fiber also adds considerable cost. If flammable glue is used to hold the foil, fire will enter cracks and flame up behind the foil. With perforations 82 in the foil 80, the tendency to bubble is reduced. With perforations 82, the generated gases and trapped air behind the foil 80 are provided methods of escape without ballooning and tearing the foil 80. The foil 80 adheres to the intumescent layer 70. Minor tearing and separation of foil 80 will occur even with perforations 82, but the effect is minimized, and intumescent material 70 tends to expand toward cracks. While various types of reinforced fibers can be used, simple aluminum foil is preferred.

The aluminum or other foil radiant barrier 80 can be applied using the freshly applied intumescent coating 70 as the adhesive. The foil 80 can be pre-perforated before application, or alternatively, the perforation is carried out after the foil 80 is applied on the substrate 60. If the perforation is carried out after the foil application, the perforation needles may be wetted by a water repellent solution to introduce water repellency at the point of perforation 82. This can be achieved by either spraying a mist of the water repellent solution on the perforation wheel, or by wetting the needles with a saturated sponge or another absorbent material. Alternatively, the perforated surface may be treated with a sponge roller to apply the water repellent. The water repellent can be any known non-flammable water repellents, for example a non-ionic reactive polysiloxane such as Sil Res BS 1360 supplied by Wacker Silicones at 2-10%.

The radiant barrier 80 may in some examples further include a water barrier material, said material disposed at least around the perforations 82 in the radiant barrier 80, to reduce the water permeability of the perforated radiant barrier 80. Commonly used intumescent material 70 is generally susceptible to water damage, where water may leach or inactivate certain compounds in the intumescent layer 70. As the radiant barrier 80 itself is largely impermeable to water, the water barrier material may be for example a silicon-based water repellent that can be rolled over the radiant barrier material 80 or applied during perforation by having perforating needles be coated with the water resistant material. The latter process allows prepared products 50 to be stacked more quickly after manufacture. It can be appreciated by one of skill in the art that applying the water resistant material to the radiant barrier 80 can be accomplished in many ways, such as by applying a pre-perforated sheet over the entire surface of the intumescent barrier 80. However, applying this water resistant material to the radiant barrier 80 during perforation allows the material to be applied only in the area it is beneficial, and since the radiant barrier 80 is already disposed on the intumescent barrier 70, the water resistant material will not impair the adhesion of the radiant barrier 80 to the intumescent layer 70. Treatment of the radiant barrier 80, or at least the perforations 82 thereon, with nonflammable water resistant material, is preferred.

When an intumescent coating 70 is used as the glue to hold the outer-facing permeable radiant barrier 80, heat and fire can activate the intumescent coating 70 to expand. The expanded foam can seal gaps, for example a ⅛″ gap caused by a saw cut or wood fixtures adjoined imperfectly, and protect the edge of the panels. The perforated foil 80 can partially or fully separate from the intumescent layer 70 but generally is maintained on the exterior of the char.

The perforations 82 in the radiant barrier 80 allow gas generated by the intumescent material 70 to partially escape, reducing the ballooning of the radiant barrier 80. While it may seem that having the intumescent barrier 80 balloon out during a fire, providing yet another beneficial insulating layer of gas to the underlying wood 60, excess ballooning of the radiant barrier 80 from the underlying intumescent barrier 70 can cause the radiant barrier 80 to tear or even detach from the underlying intumescent material 70, thereon collapsing and providing no benefit at all. While fires are extremely variable, preferably the foil 80 remains within a quarter inch, for example within an eighth of an inch, of the char from the intumescent material 70. This is readily achieved in controlled tests, especially localized tests conducted near cuts or gaps, but is also preferred in large panels and the like where there are no cuts to allow gas to escape.

The intumescent barrier 70 material can be substantially any material known to be useful, provided it had sufficient adherence to the radiant barrier 80 and to the underlying substrate 60, be it wood, processed wood, plywood, synthetic wood, and other common wood-based substrates. Examples are plywood, oriented strand board (OSB), fiber boards, particle boards, engineered wood products such as I-joist, laminated veneer lumber (LVL), lumber, cross-laminated timber (CLT), engineered wood beams such as Parallam, microlam, foam boards. In one example, the present disclosure may also be useful for foam panels, where intumescent material 70 is applied to rigid cured foam panels and the radiant barrier 80 is directly applied. The present disclosure may be applicable to steel and other metals. Clearly wood of one half inch nominal thickness ( 15/32 inch actual thickness), for example plywood, is rigid.

Depending on the application, wood-based panels 60 can be coated and foiled on one side 64 or 66 or on two sides 64, 66. Protection of the edges are not required since the intumescent coating 70 will expand and fill in the gaps at the joints. However, a thin layer of intumescent material 70 along the outer edge, even if not protected by a radiant barrier 80, can be beneficial for certain uses, especially if the manufactured products are not cut during installation.

In a preferred example the radiant barrier 80 is construction grade aluminum foil. The foil may have non-flammable fibers, such as fiberglass fibers, for added durability. Silicon water repellant applied while making holes. The intumescent layer 70 is applied directly on the wood 60. Coating the intumescent layer 70 with foil 80 will protect the intumescent layer 70 against water.

The basic components of an intumescent formulation are an acid source (e.g., ammonium polyphosphate), char former (e.g., pentaerythritol) and a blowing agent (e.g., melamine). On heating, the acid source produces an acid, which catalyzes dehydration reactions of the char former, resulting in the formation of char. In the meantime, blowing agent produces inert gas, which inflates the char. The thickness, coherence and porosity of the char determines its thermal barrier efficiency. The thick expanded char is usually more effective in prevention of the penetration of heat to underlying components of composite, when compared to thin expanded char layer. An exemplary intumescent material includes a) titanium dioxide; b) ammonium polyphosphate (CAS #68333-79-9) which when exposed to sufficient heat decomposes to polyphosphoric acid; c) a char former; and d) a foaming agent such as melamine which decomposes at about 300° C.

Ammonium polyphosphate for example decomposes around 215° C. to produce polyphosphoric acid. The acid esterifies the carbon sources between 280 and 330° C., while both of them are in semi-liquid stage. The ester decomposes via dehydration reaction resulting in the formation of a carbonaceous char. The blowing agent decomposes while char is still in a semi-liquid stage and the formed gas expands the char, into a porous structure of very low thermal conductivity. Melamine, an inexpensive blowing agent, sublimes at 250° C. and over the temperature range of 270 to 400° C. releases large amount of ammonia. As the reaction completes, solidification of the char occurs.

In a simple example of the present disclosure, an intumescent glue 70 is used to directly apply a perforated radiant barrier 80 to the wood or wood product 60, wherein the thickness of the intumescent material 70 is sufficient to provide the desired level of protection. While foil 80 of thickness 0.005 mm can be used, the thinnest foil used in experiments was 0.01 mm. The present disclosure is useful for all intumescent materials and combinations, but is particularly useful for water-based intumescent material 70. This radiant barrier 80 is directly rolled onto and pressed to the uncured intumescent material 70.

In one example, rigid wood 60 or wood containing article includes a board or sheet having an upper face 64 and a lower face 66 and the intumescent material 70 and gas permeable foil 80 is applied to at least one face 64, 66 of the board 60 or sheet. The intumescent material 70 and gas permeable foil 80 is usually applied to both the upper and the lower faces 64, 66 of the board 60 or sheet. Advantageously, sides 64, 66 not treated are coated with at least some intumescent material 70, but in other examples these sides 64 or 66 are substantially free of both intumescent material 70 and foil 80.

A preferred method of foil application is applying un-perforated foil 80 to the intumescent coating 70, followed by perforation after the coating 70 has solidified enough so that the perforations 82 are not sealed by intruding intumescent coating 70. The foil 80 may also be perforated before the coating 70 has solidified. This allows enough vapor permeability so that the UV irradiation cycle according to ICC AC479, the foil 80 does not bubble up and wrinkle due to the expansion and contraction. When pre-perforated foil 80 is applied to the wet intumescent coating 70, the foil 80 bubbles and wrinkles during the UV irradiation cycle. The stress may sometimes create large cracks in the foil 80. However, cracks as large as 15 mm do not affect the fire performance.

Preparation and characterization of the intumescent fire retardant coating 70 with a new flame retardant is described below.

A wood product 60 was protected using the methods described herein. For testing, a typical commercial formulation of an intumescent material 70 was formulated. This material contained, by weight percentages:
a) 23.87% water;
b) 0.99% of 3-Aminopropylmethyldiethoxysilane adhesion promoter (Evonik Dynasylan 1505);
c) 1.04% of a coalescing agent slow-evaporating, hydrophobic glycol ether, dipropyleneglycol n-butyl ether, having a near mid-range balance of hydrophobic and hydrophilic characteristics with 0.05% tolyltriazole corrosion inhibitor;
d) 0.20% Dispersant, in this case a functionalized polyacrylate copolymer (Tamol 1124);
e) 0.50% Defoamer, a polysiloxane mixture (BYK 1780);
f) 3.96% Filler/pigment, using titanium dioxide, or alternatively kaolin;
g) 10.50% charring agent, Pentaerythritol;
h) 10.50% blowing agent, Melamine;
i) 27.24% catalyst, Ammonium polyphosphate (phase II, n>1000);
j) 21.00% binder, Latex (Avicore 2456); and
k) 0.20% Rheology modifier (Acrysol RM-5000).

Generally, an intumescent material 70 contains latex (acts as adhesive/binder) in an amount between 15% and 25% by weight, and the char forming agent in an amount between 7% and 15% by weight. This is a typical commercial formulation for an intumescent coating 70. Please note the formulation itself is a typical commercial formulation. This formulation was selected because it is a low cost formulation and can have water issues. The only slight modifications are the addition of tolyltriazole to protect aluminum foil 80 from ammonia-instigated corrosion and the use of silicone based adhesion promoters to help the bonding strength of the aluminum foil 80 to the coating 70. It is well within the ability of one of ordinary skill in the art, with the benefit of this disclosure, to alter standard intumescent to achieve the desired level of adherence.

We emphasize that the present disclosure is applicable for all intumescent materials 70 and formulations, and not only for the “typical” example used in these examples. The function of the coalescing agent is to help the latex particles to fuse into a film. DPNB is dipropyleneglycol n-butyl ether. TTZ is tolyltriazole, a corrosion inhibitor, which helps protect the aluminum foil from corrosion.

Test samples were made using a wood product 60 to which the intumescent 70 was applied, followed by the radiant barrier 80 applied before the intumescent layer 70 had cured. The test samples were then exposed to rain/UV cycles and fire propagation tests standard in the industry, that is, according to ICC AC479.

Occasionally in early examples we observed some localized corrosion to the aluminum foil, probably due to the ammonia formed at high temperatures during the rain/UV cycle. The rain/UV cycle is one of the exposure conditions where the coated board is exposed to UV and the wood surface temperature reached 65° C. To promote long-term corrosion resistance, we added tolyltriazole at 5 ppm based on the weight of the formulation. Any corrosion inhibitor that is compatible with the intumescent material 70 and with the radiant barrier 80 material can be used. For example, most commercially available azole-based corrosion inhibitors can be used. The amount should be small, for example less than 50 ppm by weight. If a second adhesive intumescent layer is utilized to promote adhesion to the radiant barrier 80, this layer can have more corrosion inhibitor.

The composition above is used as the adhesive to laminate the aluminum foil 80 to plywood 60 or OSB. Application rate varies from 25 to 1000 grams/square meter, more typically 140 to 1000 grams/square meter (13-93 grams/square foot). The intumescent composition 70 is applied to the wood substrate 60, then the foil 80 is applied to the wet board 60. Pressure can be applied by a brush, or a compressible roller, e.g., a foam roller or a rubber roller. The pressure and the perforation can be done using a single roller or two separate rollers.

The use of silicone-based adhesion promoters help the bonding strength of the aluminum foil 80 to the coating 70. We found with no Evonik 1505 (an adhesion promoter) the adhesion strength was 97.6 psi, with 1% Evonik 1505 concentration the adhesion strength was 120.8 psi, and with 2% Evonik 1505 the adhesion strength was 140.2 psi. The above composition was applied as a single layer.

Alternatively, the adhesive intumescent 70 can be applied in two layers. The main layer having the composition above is applied to the wood substrate 60. A second composition, called here a primer layer, which has higher amount of latex and lower amounts of fire retardants, is applied to the foil 80 before the foil 80 is pressed on the wet intumescent layer 70. Of course, adding one layer atop another, with or without partial curing, can be achieved in any number of ways. We selected placing the “primer” intumescent onto the foil 80 for ease of application. The primer composition has the following formula, again by weight:
Water, 34.16%
Dispersant (Tamol 1124), 0.28%
Defoamer (BYK 1780), 0.71%
Pentaerythritol, 7.51%
Melamine, 7.51%
Ammonium polyphosphate, 19.49%
Latex (Avicore 2456), 30.05% and
Rheology modifier (Acrysol RM-5000), 0.28%.

Generally, the primer contains latex (acts as adhesive) in an amount between 20% and 40% by weight, and the char forming agent in an amount between 5% and 15% by weight.

The advantages of having two layers is to maximize performance. The main intumescent layer has high levels of fire retardant for high performance. The second layer, which has high levels of latex but is still intumescent, provides better water resistance and better adhesion. Again, this second layer can advantageously include corrosion protectants, adhesion promoters, or both.

The primer layer can be applied at a rate of 30-200 grams per square meter. When the primer layer is used, the adhesion promoter is not required in the main intumescent layer.

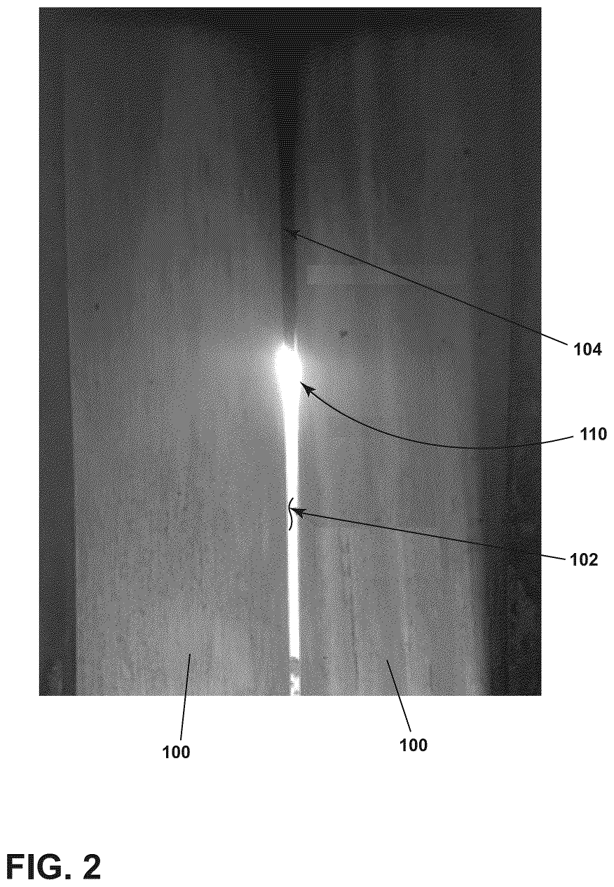

In an ASTM E162 test, the Radiant Panel Flame Spread Apparatus measures the surface flammability of building products (ASTM E162) by using a gas-fired radiant heat panel. The test result is an index that is determined from the flame spread and heat evolution factors. The ICC AC479 also requires the wood products to meet the ASTM E84 fire test when the wood product is cut, i.e. when there are un-protected edges. It is also required that when nails penetrate the coated surface, the fire performance is not impacted. As shown in FIG. 2, the intumescent coating can expand during the fire test to seal the ⅛″ gap 102 partially or completely so that the fire performance is not negatively impacted. Nail penetration through the coating and the foil does not impact the fire performance.

FIG. 2 shows a sample wood product 100 coated with 33 g. per square foot intumescent material and a 0.01 mm thick aluminum foil, unperforated, on a single side. The photo shows the fire resistance test setup including a tester pilot flame 110 and a gap 102 purposely left, per test protocol, between the wood products 100 to evaluate the intumescent material's ability to expand and protect joints or gaps 102 in construction, which is shown by the lower portion of the gap 102 where it is not hot enough for the intumescent material coating to expand and the upper portion of the gap 102 that has been sealed by expanding foam 104.

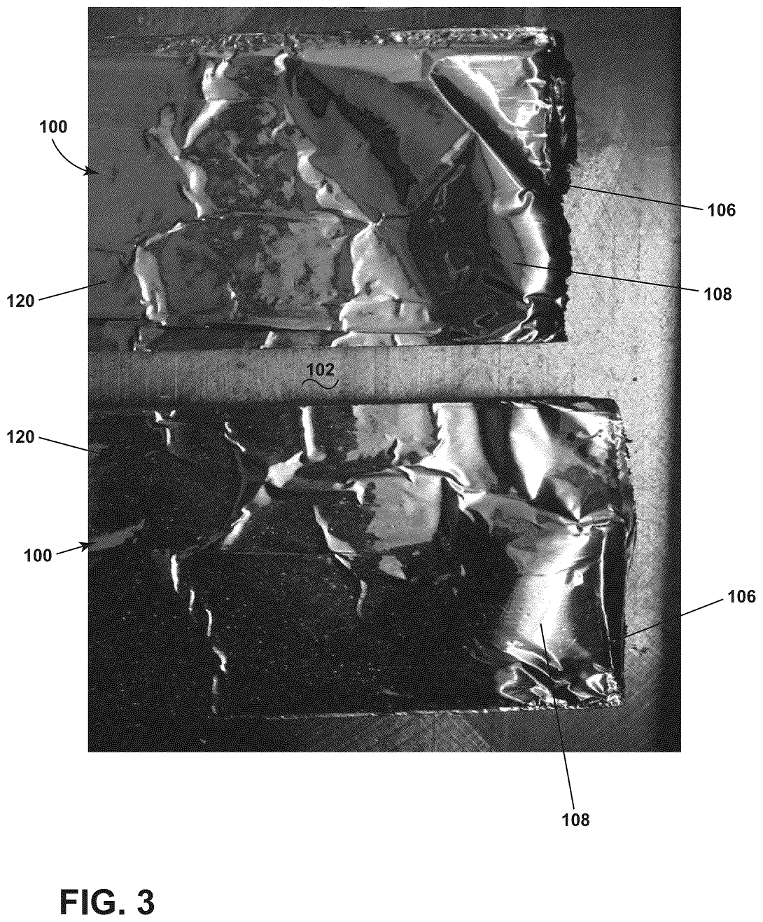

FIG. 3 shows the same sample wood product 100 coated with 33 g. per square foot intumescent material and the 0.01 mm thick aluminum foil 120, unperforated, on a single, protected side after an E 162 fire resistance test exposing the protected side to a heat source. The sample wood product 100 is separated to more clearly show the gap 102. The bubble 108 was apparently caused by an air gap between the intumescent material and the unperforated radiant barrier foil 120. There was very little char 106 at the top.

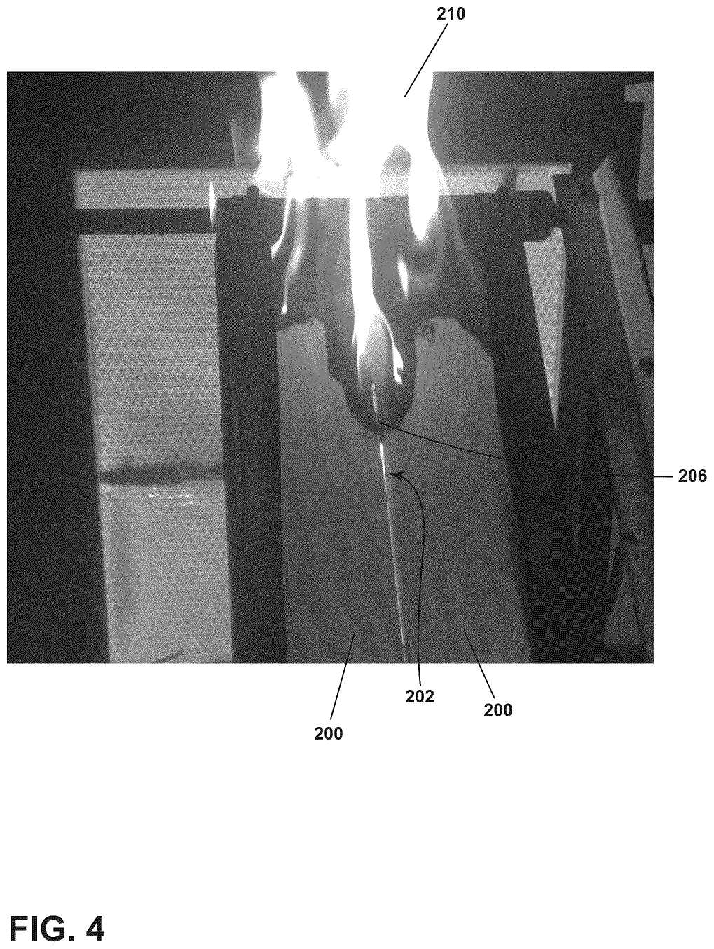

FIG. 4 shows a similar sample wood product 200 coated with 33 g. per square foot intumescent material and a foil, unperforated, on a single side that, after undergoing a fifteen minute E 162 test, had a ⅛ inch gap 202 cut and was again subjected to the fire resistance test. There was no flaming for over 10 minutes, with snake-like char 206 filling the gap 202. At 13 minutes, the upper unprotected back of the wood product 200 board caught fire 210, and the other fire started showing around the gap 202.

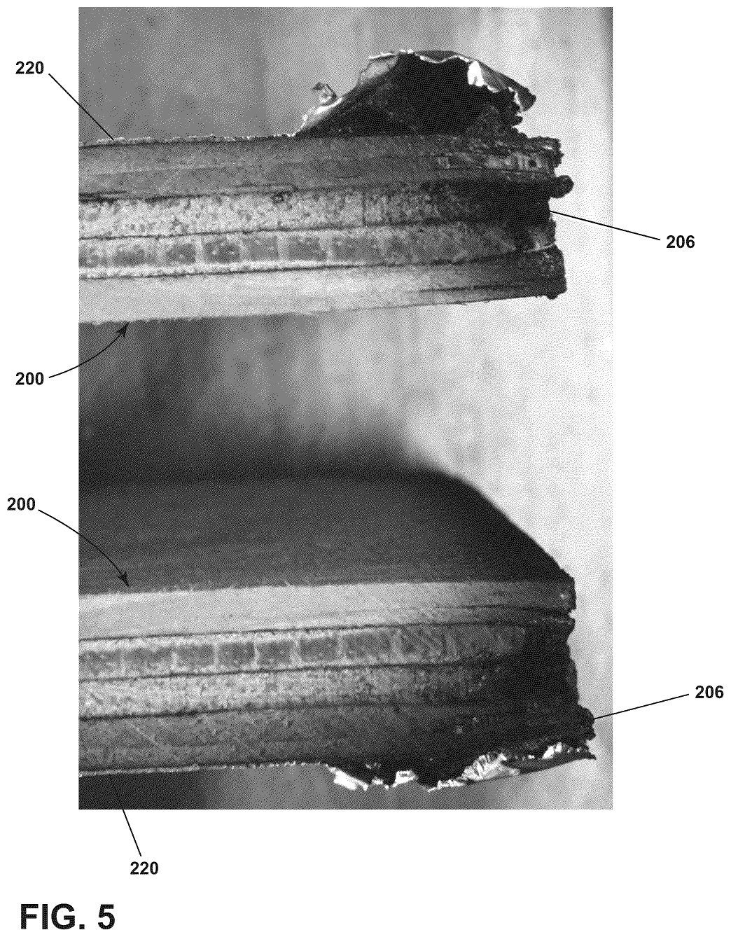

FIG. 5 shows the sample wood product 200 coated with 33 g. per square foot intumescent material and a 0.01 mm thick aluminum foil 220, unperforated, on a single side that, after undergoing a fifteen minute E 162 fire resistance test, had a ⅛ inch gap 202, shown here in a side view of the gap 202.

A sample having 60 g intumescent per square foot on one side, with non-perforated 0.01 mm aluminum foil, and having a ⅛ inch gap, was tested in a similar manner. Two large bubbles formed behind the foil during the E162 test, one near the pilot flame and the second near the top of the foil. Again, it is believed that these were caused by air pockets. After the test, the sample was cut in half and the test repeated with a ⅛ inch gap between samples right at the pilot flame. There was no flaming in the front or back.

Tests were run with 0.02 mm foil. With 33 g intumescent per square foot on one side, char filled the gap, but flames were observed on the back after 10 minutes. With 47 g intumescent per square foot on one side, there was no flame observed on the front of the panel, but a small flame was observed on the back before tests were completed. With 60 g intumescent per square foot on one side, no flames were observed on either side of the panel during the test, despite the gap near the top reaching a width of 3/16^{th} inch.

In the ASTM E162 fire testing, Fs is the flame spread factor. Fs=1.0 is the best rating possible, indicating that the either the test material did not flame, or the flame did not travel to the 3″ mark during the test duration. The Q value is the heat factor, which measures the relative heat generated by the test material. The value Fs*Q is an overall measure of the fire performance, where a smaller value indicates better performance. As a comparison, a code-compliant FRTW (fire retardant treated wood) material has an Fs*Q value of 5 to 50. A number of tests were performed with perforated foil. All tests in Table 1 used 33 g per square foot intumescent.

TABLE 1
ASTM E162 Fire performance of Examples

| Sample Description | Fs | Q | Fs * Q |
|---|---|---|---|
| Pre-perforated foil | 1.0 | 3.01 | 3.01 |
| Post-perforation | 1.0 | 5.46 | 5.46 |
| Post-perforation, brush-on | 1.0 | 2.97 | 2.97 |
| with 2% BS 1360 | | | |
| Post-perforation, wetting | 1.0 | 4.49 | 4.49 |
| needle with 2% BS 1360 | | | |
| Pre-perforated foil with | 1.0 | 3.22 | 3.22 |
| gap and nail penetration | | | |

All of these samples provided performance equal or better to fire retardant treated wood standards. Pre-perforated foil seems to have better fire resistant characteristics.

One of the challenges for a fire retardant coating is its water resistance. Even for interior applications, the coating is required to have certain water resistance to deal with exposures during the construction stage. For water based intumescent coatings, water resistance is a particular challenge. It was discovered that the use of aluminum foil can effectively provide the required water resistance according to ICC AC-479. The aluminum foil radiant barrier 80 was applied using the freshly applied intumescent coating 70 as the adhesive. The foil 80 in one example was pre-perforated before application, and in other examples the perforation was carried out after the foil 80 was applied on the substrate 60.

For those examples where the perforation was carried out after the foil application, in one example the perforation needles were wetted by a water repellent solution to introduce water repellency at the point of perforation. In other examples, the perforated surface was treated with a sponge roller to apply the water repellent. The water repellent used was Sil Res BS 1360 supplied by Wacker Silicones at 2-10%.

The most preferred method of foil application involved applying un-perforated foil 80 to the intumescent coating 70, followed by perforation after the intumescent coating 70 had solidified enough so that the perforation was not sealed by the intumescent coating 70. This allowed enough vapor permeability so that the UV irradiation/water spray cycle according to ICC AC479, the foil 80 did not bubble up and wrinkle due to the expansion and contraction. When pre-perforated foil 80 was applied to the wet intumescent coating 70, the foil 80 bubbled and wrinkled during the UV irradiation/water spray cycle. The stress sometimes created cracks in the foil 80. However, cracks as large as 15 mm do not affect the fire performance.

Panels 50 can be stacked as soon as the foil 80 is applied, and perforations 82 created. This saves the need of forced drying the coating 70. Additionally, the foil functions as radiant barrier 80 for energy efficiency. Depending on the application, construction panels 50 can be coated and foiled on one side or two sides 64, 66. Protection of the edges are not required since the intumescent coating 70 will expand and fill in the gaps at the joints.

Perforation of the foils 80 results in an increase of the drying rate of panel products 50. A perforation 82 size of 0.1 mm approximately doubles the drying rate. One example of the present disclosure utilizes pre-perforation of the facings 80 because this has the advantage of eliminating the occasional formation of gas blisters between the radiant barrier 80 and the intumescent material layer 70. These blisters can occur when manufacturing with a gas-tight facing and results in a gas bubble between the facing 80 and the intumescent surface 70 with loss of facing adhesion in that area. These blisters are undesirable.

The ICC AC479 also requires the wood products to meet the ASTM E84 fire test when the wood product is cut, i.e. when there are un-protected edges. It is also required that when nails penetrate the coated surface, the fire performance is not impacted. As shown in the photo FIG. 2, the intumescent coating expanded during the fire test to seal the ⅛″ gap partially or completely so that the fire performance is not negatively impacted. The lower portion of the saw cut was not sealed because the material did not reach a sufficient temperature, which was a factor of the test equipment used. Nail penetration through the coating and the foil did not impact the fire performance.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods.

The features disclosed in the foregoing description or in the accompanying drawings may, both separately and in any combination thereof, be material for realizing aspects in diverse forms thereof.

What is claimed:

1. A method of forming a protected wood product, the method comprising:
coating a first side of a rigid body with an intumescent material, the intumescent material being a wet paste or liquid, the intumescent material comprising a binder, a blowing agent, and a charring agent, the rigid body having the first side and a second side, the second side opposing the first side, and wherein at least the first side is a wood, a wood product, or a wood composite;
pressing a metal foil radiant barrier to the intumescent material, the metal foil radiant barrier comprising a plurality of perforations; and
curing the intumescent material after the pressing.

2. The method of claim 1, wherein the plurality of perforations of the metal foil radiant barrier comprise a plurality of slits.

3. The method of claim 2, wherein at least one slit of the plurality of slits includes a length at least 3 times a width of the at least one slit.

4. The method of claim 1, wherein at least one of the plurality of perforations comprise a profile having an angle.

5. The method of claim 1, wherein at least some of the plurality of perforations are U-shaped or V-shaped.

6. The method of claim 1, wherein the metal foil radiant barrier is disposed directly over the intumescent material.

7. The method of claim 1, wherein the intumescent material further comprises adhesion-promoting compounds.

8. The method of claim 7, wherein the adhesion-promoting compounds comprise silicone-based adhesion-promoting compounds.

9. The method of claim 1, further comprising pre-perforating the metal foil radiant barrier prior to the pressing of the metal foil radiant barrier to the intumescent material.

10. The method of claim 1, further comprising perforating the metal foil radiant barrier after the pressing of the metal foil radiant barrier to the intumescent material.

11. The method of claim 1, wherein coating the first side of the rigid body with the intumescent material comprises applying 30-60 grams of the intumescent material per square foot of the first side.

12. A manufactured fire resistant wood-based product, comprising:
an intumescent layer disposed on at least a portion of a rigid body, the rigid body being a wood body, a wood product body, or a wood composite body, wherein the intumescent layer is substantially covered by a non-flammable radiant barrier disposed directly on the intumescent layer and wherein the non-flammable radiant barrier is perforated.

13. The manufactured fire resistant wood-based product of claim 12, wherein less than 5% of an area of the non-flammable radiant barrier includes perforations.

14. The manufactured fire resistant wood-based product of claim 13, wherein less than 1% of the area of the non-flammable radiant barrier includes perforations.

15. The manufactured fire resistant wood-based product of claim 12, wherein the intumescent layer comprises an intumescent coating.

16. The manufactured fire resistant wood-based product of claim 15, wherein the intumescent coating comprises first and second layers disposed one over the other.

17. The manufactured fire resistant wood-based product of claim 15, wherein the intumescent coating comprises a single layer.

18. The manufactured fire resistant wood-based product of claim 12, wherein the non-flammable radiant barrier comprises a metal foil.

19. The manufactured fire resistant wood-based product of claim 18, wherein the metal foil comprises aluminum foil.

20. The manufactured fire resistant wood-based product of claim 12, wherein the radiant barrier has a thickness of less than 0.02 inches.
